(19) United States
(12) Patent Application Publication
(10) Pub. No.: US 2008/0013039 A1
(43) Pub. Date: Jan. 17, 2008

(54) INTERCHANGEABLE EYEWEAR ASSEMBLY

(76) Inventors: Ira Lerner, New York, NY (US); Toshiro Fujiuchi, Sakai-gun (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/777,742

(22) Filed: Jul. 13, 2007

Related U.S. Application Data
(63) Continuation of application No. 10/957,213, filed on Oct. 1, 2004, now abandoned.
(60) Provisional application No. 60/508,668, filed on Oct. 2, 2003.

(51) Int. Cl. G02C 1/00

(52) U.S. Cl. 351/58

(57) ABSTRACT

An eyewear system enables a person to switch lenses among a variety of frames or switch a variety of lenses within a single frame. The lenses are positioned in one or more subframe assemblies that can be easily attached to and detached from a frame assembly that may not otherwise contain lenses.

### RELATED APPLICATIONS

This application is a continuation of U.S. patent application Ser. No. 10/957,213, filed Oct. 1, 2004, which claims the priority benefit under 35 U.S.C. §119(e) of U.S. Provisional Patent Application No. 60/508,668, filed on Oct. 2, 2003, which is hereby incorporated by reference in its entirety.

### BACKGROUND OF THE INVENTION

1. Field of the Invention

The present invention generally relates to eyewear frames and lenses. More particularly, the present invention relates to an eyewear assembly in which a single set of lenses can be inserted and removed from behind a plurality of frames or multiple sets of lenses can be inserted and removed from behind a single frame.

2. Description of the Related Art

The cost of quality prescription lenses has risen dramatically in the past ten years. Many people who wear eyeglasses today desire so-called progressive lenses in which the power of the lens varies along the surface of the lens. Unfortunately, progressive lenses are more expensive than ordinary prescription lenses or bifocal lenses. Additionally, a type of thin lens that is designed to replace a relatively thicker lens also is available but has an elevated cost. Further, coatings and the like can be added to a lens to, for example, reduce glare or allow the lens to change tint. These coatings also increase the cost of the lens.

At the same time, people who wear eyeglasses often purchase more than one pair of eyeglasses for different functional and aesthetic reasons. For instance, different eyeglasses may be purchased to increase strength or comfort, to alter the fit or the weight, to vary the flexibility or the rigidity or to provide a different aesthetic look by changing the shape of the frame or the coloring of the frame. This, of course, requires the purchase of a complete set of eyewear, including the frame and the expensive prescription lenses.

On the other hand, some people purchase more than one pair of eyewear having a single style of frame but use one of the frames for tinted lenses and the other for non-tinted lenses. Of course, these people must then carry both pair of eyewear and must absorb the additional costs associated with the second frame.

### SUMMARY OF THE INVENTION

It would be desirable to create a system of eyewear that enables a person to use a single pair of lenses with multiple frame structures or a single frame structure with multiple pairs of lenses.

In the first arrangement, the frame structures can vary among one another by virtue of functionality, features or aesthetic appearance. As such, variations among the frames can be provided by design, materials used, coloring, shape, decorations, construction or the like. Such a system would allow a person who wears eyewear to have several sets of frames without the need for more than one set of lenses.

In the second arrangement, the lenses can vary among one another by virtue of tinting or magnification features, for instance. Different eyeglass lenses may also be purchased for various vision correcting purposes, for purposes such as glare reduction, magnification, protection from UV rays, lighter weights, as for aesthetic reasons such as thinness of the lenses, tints and coloring of the lenses. Thus, a person can maintain a single frame in which the lenses are removed and replaced quickly and easily to accommodate changes in the lenses. For instance, sun lenses can be installed in place of clear lenses or a magnifying lens can be used in place of a wearer's usual lens.

Accordingly, one aspect of certain embodiments of the present invention involves providing a user with one pair of lenses that can be easily attached and detached to a plurality of complementary frame designs.

Another aspect of certain embodiments of the present invention involves enabling a user to remove the lenses from one frame and insert the lenses in another frame without the use of mechanical tools or equipment or enabling a user to remove at least one lens from a frame and replace that lens with another lens without the use of mechanical tools or equipment.

A further aspect of certain embodiments of the present invention involves enabling an eyeglass wearer to easily attach to and detach from a single pair of lenses multiple frames without contacting with one's fingers a region of the lenses through which one looks.

An aspect of the present invention also involves an eyeglass assembly comprising a frame assembly and a subframe assembly. The frame assembly comprises a pair of temples, a front side and a back side. The back side of the frame assembly is closer to a wearer's face than the front side. The subframe assembly comprises at least one lens. The subframe assembly also comprises a front side and a back side. The back side of the subframe assembly is closer to the wearer's face than the front side of the subframe assembly. The subframe assembly is secured to the frame assembly at least in part by at least one pair of magnetic members such that the front side of the subframe assembly faces the back side of the frame assembly and the subframe assembly is at least partially positioned between the frame assembly and the wear's face. A first magnetic member of the at least one pair of magnetic members is a magnet that is secured to one of the frame assembly and the subframe assembly and a second magnetic member of the at least one pair of magnetic members is a magnet or a material that is attracted to a magnet and the second magnetic member being secured to the other of the frame assembly and the subframe assembly such that the first magnetic member and the second magnetic member are generally aligned when the subframe assembly is secured to the frame assembly.

Another aspect of the present invention involves an eyeglass assembly comprising a frame assembly and a subframe assembly. The frame assembly comprises a front side and a back side with the back side being closer to a face of a wearer than the front side. The frame assembly further comprises a first brow bar, a second brow bar and a bridge connecting the first brow bar to the second brow bar. A first projection extends from the first brow bar and a second projection extends from the second brow bar. A first temple is connected to the first projection and a second temple connected to the second projection. The subframe assembly comprises a front side and a back side. The back side is closer to the face of a wearer than the front side. The subframe assembly further comprises a brow bar with a lens being secured to the brow bar. The subframe assembly is secured to the frame assembly such that the front side of the subframe assembly faces the back side of the frame assembly and such that the front side of the subframe assembly generally is positioned rearward of the front side of the frame assembly.

A further aspect of the present invention involves a method of exchanging lenses in an eyewear system. The eyewear system comprises a first subframe assembly that comprises a first lens, a second subframe assembly that comprises a second lens, the second lens not being matched to the first lens, and a frame assembly that will accommodate individually both the first subframe assembly and the second subframe assembly. The method comprises releasing and removing the first subframe assembly from behind the frame assembly, placing the second subframe assembly behind the frame assembly and securing the second subframe assembly to the frame assembly.

A further aspect of the present invention involves a method of exchanging lenses in an eyewear system. The eyewear system comprises a first subframe assembly that comprises a first lens and a second lens, and at least a second subframe assembly that comprises a different first lens and a different second lens, and a frame assembly that will accommodate individually each subframe assembly, which is not limited in number. In other words, three, four or more subframes can be used. The method comprises releasing and removing the first subframe assembly from behind the frame assembly, placing the second subframe assembly behind the frame assembly and securing the second subframe assembly to the frame assembly.

An additional aspect of the present invention involves a method of exchanging frames in an eyewear system. The eyewear system comprises a first frame assembly that does not comprise a lens, a second frame assembly that does not comprise a lens, and a subframe assembly that comprises a lens where the subframe assembly is sized and configured to be accommodated within the first frame assembly and the second frame assembly. The method comprises releasing and removing the subframe assembly from behind the first frame assembly, placing the subframe assembly behind the second frame assembly and securing the subframe assembly to the second frame assembly.

### BRIEF DESCRIPTION OF THE DRAWINGS

These and other features, aspects and advantages of the present invention will now be described with reference to the drawings of several preferred embodiments. The illustrated embodiments are intended to illustrate and not to limit the invention. The drawings comprise the figures briefly described below.

FIG. 1 is a front elevation view of a first eyewear assembly comprising a first frame and a first pair of lenses.

FIG. 2 is a front elevation view of the first pair of lenses.

FIG. 3 is a side elevation of the first eyewear assembly as presented in FIG. 1.

FIG. 4 is a top plan view of the first eyewear assembly as presented in FIG. 1.

FIG. 5 is a perspective view of a portion of the first eyewear assembly as presented in FIG. 1 with the first pair of lenses shown removed from the first frame.

FIG. 6 is a section view taken along the line 6-6 in FIG. 4.

FIG. 7 is a front elevation view of a second eyewear assembly comprising a first frame and a first pair of lenses.

FIG. 8 is a front elevation view of the first pair of lenses of the second eyewear assembly.

FIG. 9 is a side elevation of the second eyewear assembly as presented in FIG. 7.

FIG. 10 is a top plan view of the second eyewear assembly as presented in FIG. 7.

FIG. 11 is a top plan view of the first pair of lenses as presented in FIG. 7.

FIG. 12 is a top plan view of the first frame as presented in FIG. 7.

FIG. 13 is a section view taken along the line 13-13 in FIG. 12.

FIG. 14 is a front elevation view of a third eyewear assembly comprising a first frame and a first pair of lenses.

FIG. 15 is a front elevation view of the first pair of lenses of the third eyewear assembly.

FIG. 16 is a side elevation of the third eyewear assembly as presented in FIG. 14.

FIG. 17 is a top plan view of the third eyewear assembly as presented in FIG. 14.

FIG. 18 is a perspective view of a portion of the first pair of lenses as presented in FIG. 14.

FIG. 19 is a perspective view of a portion of the first frame as presented in FIG. 14.

FIG. 20 is a top plan view of a portion of the first pair of lenses as presented in FIG. 14.

FIG. 21 is a top plan view of a portion of the first frame as presented in FIG. 14.

FIG. 22 is a front elevation view of a fourth eyewear assembly comprising a first frame and a first pair of lenses.

FIG. 23 is a front elevation view of the first pair of lenses of the fourth eyewear assembly.

FIG. 24 is a side elevation of the fourth eyewear assembly as presented in FIG. 22.

FIG. 25 is a top plan view of the fourth eyewear assembly as presented in FIG. 22.

FIG. 26 is a perspective view of a portion of the fourth eyewear assembly as presented in FIG. 22 with the first pair of lenses shown removed from the first frame.

FIG. 27 is a front elevation view of a fifth eyewear assembly comprising a first frame and a first pair of lenses.

FIG. 28 is a front elevation view of the first pair of lenses of the fifth eyewear assembly.

FIG. 29 is a side elevation of the fifth eyewear assembly as presented in FIG. 27.

FIG. 30 is a top plan view of the fifth eyewear assembly as presented in FIG. 27.

FIG. 31 is a perspective view of a portion of the fifth eyewear assembly as presented in FIG. 27 with the first pair of lenses shown removed from the first frame.

FIGS. 32A and 32B are a perspective view of a portion of the fifth eyewear assembly as presented in FIG. 27 with the first pair of lenses shown installed on the first frame.

FIG. 33 is a front elevation view of a sixth eyewear assembly comprising a first frame and a first pair of lenses.

FIG. 34 is a front elevation view of the first pair of lenses of the sixth eyewear assembly.

FIG. 35 is a side elevation of the sixth eyewear assembly as presented in FIG. 33.

FIG. 36 is a top plan view of the sixth eyewear assembly as presented in FIG. 33.

FIG. 37 is a perspective view of a portion of the sixth eyewear assembly as presented in FIG. 33 with the first pair of lenses shown removed from the first frame.

FIG. 38 is a perspective view of a portion of the sixth eyewear assembly as presented in FIG. 33 with the first pair of lenses shown installed on the first frame.

FIG. 39 is a front elevation view of a seventh eyewear assembly comprising a first frame and a pair of first lenses.

FIG. 40 is a front elevation view of the pair of first lenses of the seventh eyewear assembly.

FIG. 41A is a perspective view of one of the first lenses being connected to the first frame of the seventh eyewear assembly as presented in FIG. 39.

FIG. 41B is a perspective view of the first lens showing in FIG. 41A after being rotated into position on the first frame of the seventh eyewear assembly as presented in FIG. 39.

FIGS. 42A and 42B illustrate in front view the fitting of the lens to the frame shown in FIGS. 41A and 41B.

FIG. 43 is a front elevation view of the first frame of the seventh eyewear assembly as presented in FIG. 39.

FIG. 44 is a front elevation view of the pair of first lenses of the seventh eyewear assembly.

FIG. 45 is a side elevation view of the seventh eyewear assembly.

FIG. 46 is a perspective view of a portion of the seventh eyewear.

FIG. 47 is a sectioned view taken along the line 47-47 in FIG. 46.

FIG. 48 is a partially sectioned view of a portion of the seventh eyewear assembly showing a connection between one of the first lenses and the first frame.

FIG. 49 is a front elevation view of an eighth eyewear assembly comprising a first frame and a first pair of lenses.

FIG. 50 is a front elevation view of the first pair of lenses of the eighth eyewear assembly.

FIG. 51 is a top plan view of the eighth eyewear assembly.

FIG. 52 is a perspective view of a portion of the eighth eyewear assembly.

FIGS. 53 and 54 illustrate in schematic fashion that a single pair of lenses can be used interchangeably with a plurality of frames to create some flexibility in eyewear fashion and function.

FIG. 55 illustrates in schematic fashion that a single frame assembly can be used with a variety of different lens combinations.

### DETAILED DESCRIPTION OF THE PREFERRED EMBODIMENT

Prior to describing each of the illustrated embodiments, some general comments are set forth. As shown in the drawings, various mechanisms can be provided by which a set of lenses can be removably connected to a frame assembly. In most embodiments of the present invention, the lens assembly will be mounted rearward of a front surface, and more preferably a rear surface, of the frame assembly. Desirably, the frame assembly will obscure at least a portion of the lens assembly. As such, certain features, aspects and advantages of the present invention can be used with eyeglasses, sunglasses, goggles, protective eyewear and the like.

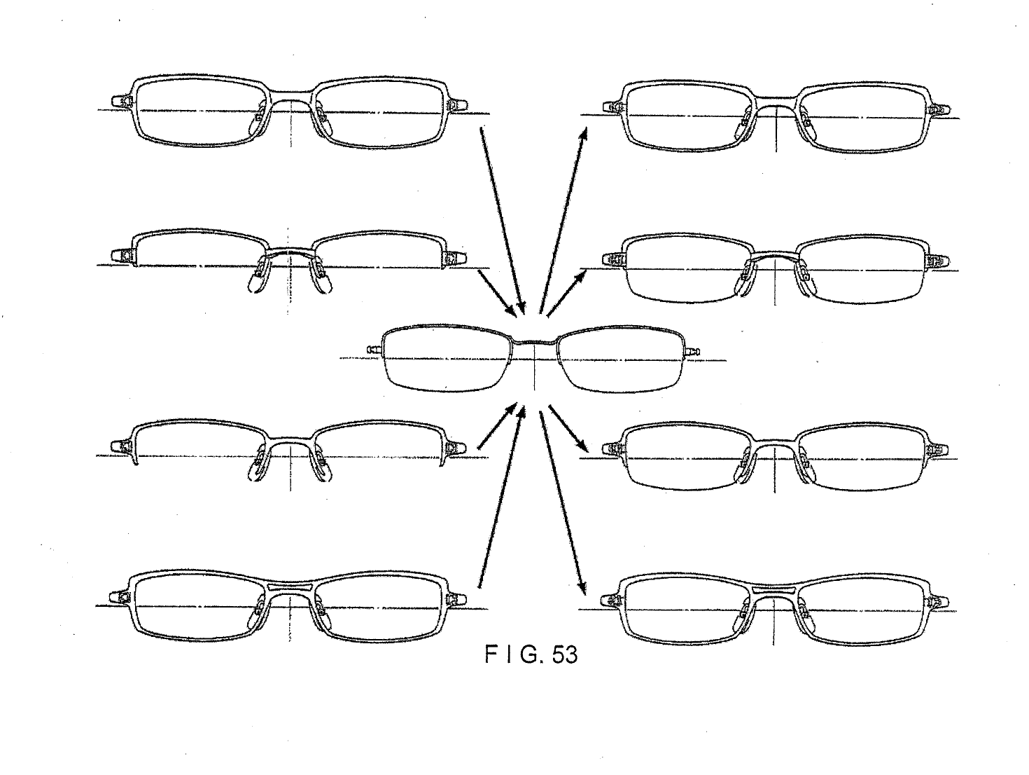

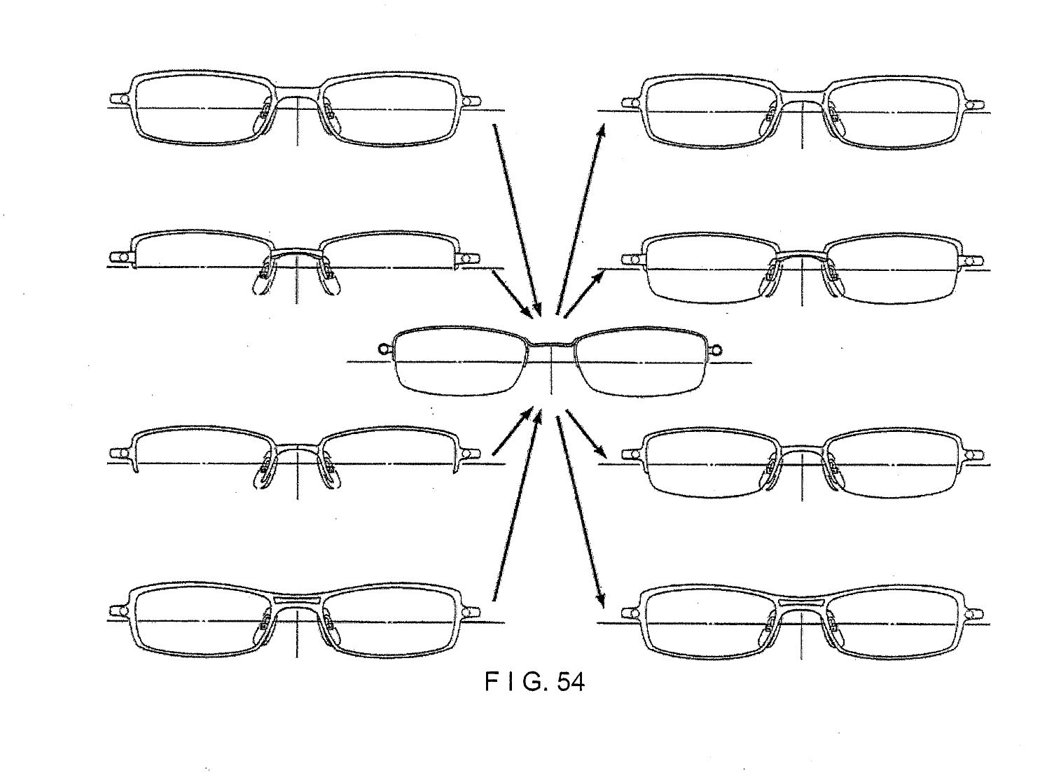

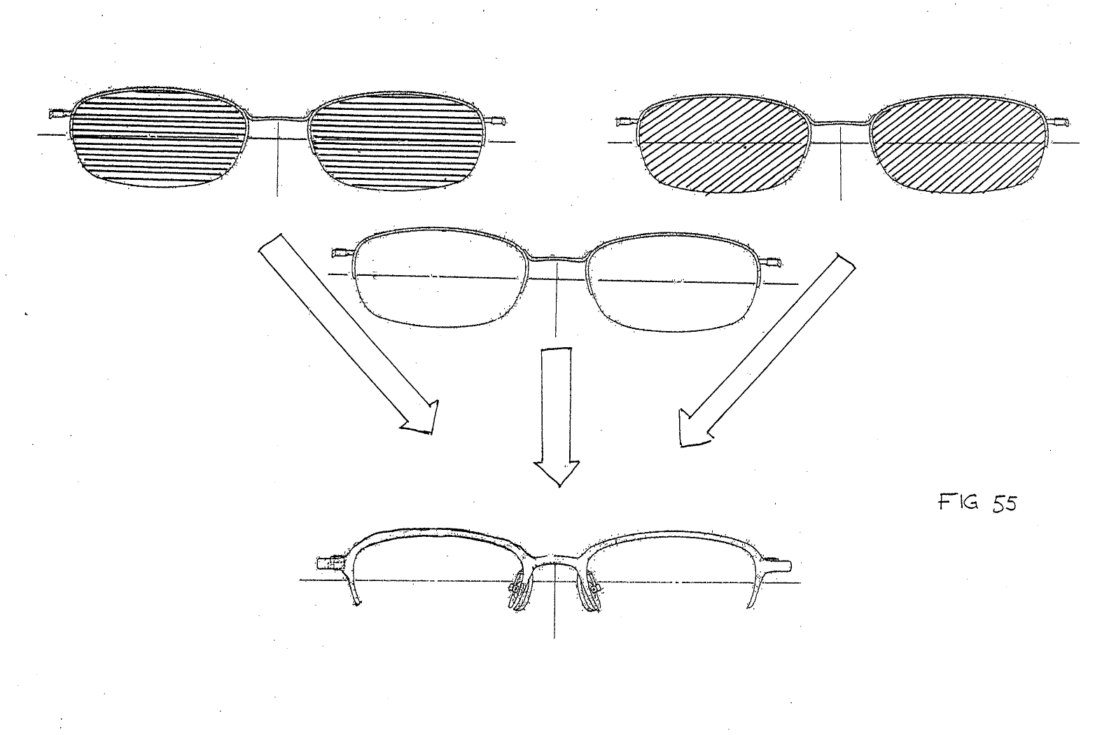

Thus, either the lenses can be replaced by other lenses relative to a single frame assembly or the frame assembly can be replaced by another frame assembly relative to the lenses or both. In one embodiment, auxiliary lenses can be placed behind the primary lenses such that magnifiers, sun lenses, corrective lenses or the like can be positioned behind a primary lens. As shown in FIGS. 53 and 54, a single set of lenses contained in a subframe assembly can be installed in any number of frame assemblies to provide completed eyewear. FIG. 53 shows an arrangement with a mechanical interconnection between the subframe assembly and the frame assembly while FIG. 54 shows an arrangement with a magnetic interconnection between the subframe assembly and the frame assembly. FIG. 55 illustrates the use of a single frame assembly with subframe assemblies comprising blue lenses, brown lenses and clear lenses. Other lens variations also can be used. Configurations such as those shown in FIGS. 53-55 will address the desires to use either a single set of lenses with multiple frames, a single frame with multiple sets of lenses or multiples sets of lenses with multiple frames.

As used herein and as discussed in further detail below, the frame assembly preferably comprises a brow bar, a pair of temples and a bridge but other suitable frame assemblies also can be used. The frame can be made of any suitable material and in any suitable manner. Notably, the frame assembly advantageously is not provided with any lenses that are secured within optical openings of the frame assembly in any typical fashion.

Instead, the lenses preferably are mounted in the sub-frame or in a pair of sub-frames that are independently mountable to the frame assembly. The sub-frame or sub-frames in the illustrated arrangements preferably do not feature temples or nose support pads. Instead, once mounted in the frame assembly, the frame assembly provides these components. In some embodiments, however, the frame assembly may be made without the temples and/or the nose support pads and these components can be mounted to the sub-frame or sub-frames. Such a construction, however, reduces the illusion of an integrated frame and lens assembly. The sub-frame preferably is of the semi-rimless variety to increase the number of frame assembly variations with which the sub-frame can be used. In some embodiments, the sub-frame can comprise a very narrow frame, however, the integrity of the frame assembly can become a concern in such embodiments.

The illustrated embodiments depict two general types of interconnection techniques with which the subframe assembly can be secured to the frame assembly: magnetic interlock and mechanical interlock. A combination of a magnetic interlock and a mechanical interlock also can be used. While a few mechanical interlocking constructions are illustrated, a variety of other suitable types of interlocking constructions also can be used. In some arrangements, these mechanical interlocks can be snap-fit. With respect to the magnetic interlock, magnetic members are provided on at least one of the frame assembly or the lens assembly. The magnetic members can be a magnet or a material that is attracted to a magnet (e.g., a ferrous metal). Therefore, each pair of attracting magnetic members includes at least one magnetic member that is a magnet while the other magnetic member may be a magnet or a material that is attracted to a magnet. The magnetic members can have any suitable shape and size. The magnetic members can be embedded, recessed, positioned flush with or raised from the surface to which or in which the magnetic member is secured. Preferably, a pair of magnetic members is provided such that one of the pair is in or on the frame assembly and the other is in or on a corresponding region of the subframe assembly. The magnetic members can be attached in any suitable manner, including without limitation, embedding, adhering, or through the use of a sleeve or housing. In some embodiments, the frame assembly or the subframe assembly can include a component made of a magnetic member, such as a brow bar or the like. The magnetic members can be used to join the frame assembly to the subframe assembly regardless of whether there is direct contact between the paired magnetic members. Accordingly, “magnetically secured” means that the magnetic force between the respective magnetic members is sufficient to hold the subframe assembly in a usable position relative to the frame assembly.

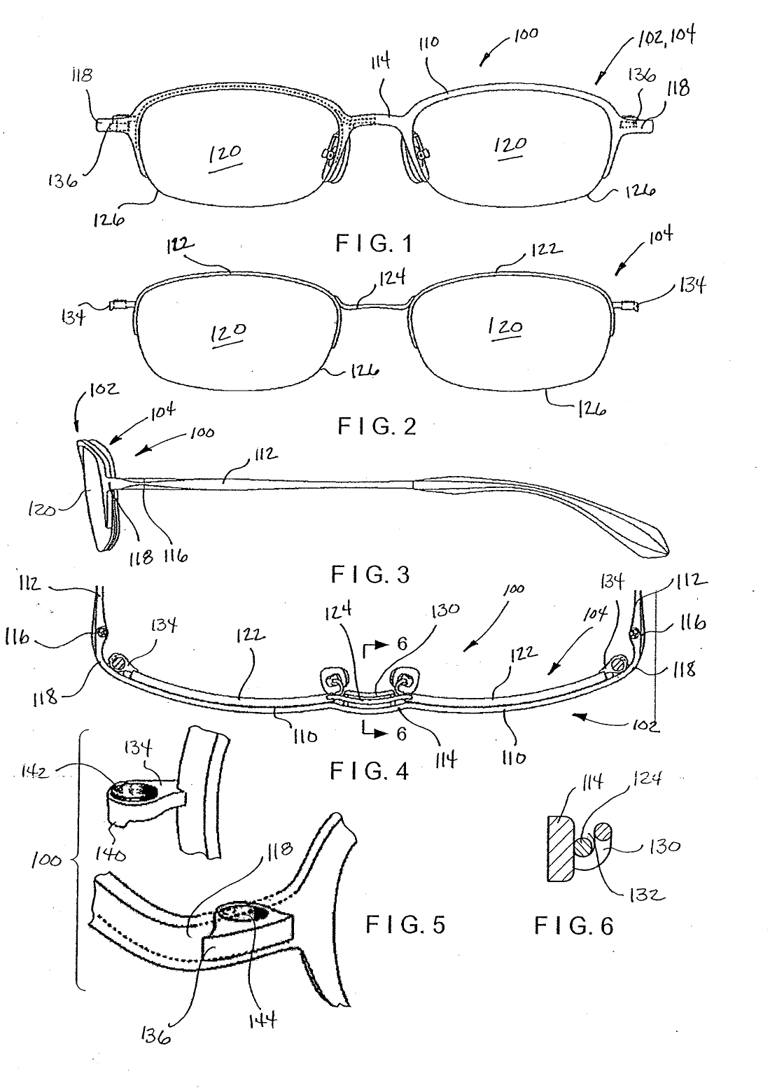

The specific illustrated embodiments now will be described, beginning with the embodiment illustrated in FIGS. 1-6. In the arrangement of FIGS. 1-6, the eyewear 100 generally comprises a frame assembly 102 and a lens subframe assembly 104 (see, for example, FIG. 2). As introduced above, the lens subframe assembly 104 preferably is mountable to the frame assembly 102 rearward of the frame assembly 102 such that at least a portion of the lens subframe assembly 104 will be positioned between the frame assembly 102 and the eye of a wearer. As used herein, the term rearward means on the side adjacent the eyes and forward means in the opposite direction.

The frame assembly 102 preferably comprises a brow bar 110, a pair of temples 112 and a bridge 114. The brow bar 110 and the temples 112 can be connected in any suitable manner. In the arrangement illustrated in FIGS. 1 and 3, corresponding hinges 116 connect the temples 112 to the brow bar 110. More particularly, projections 118 extend from the brow bar 110 and the hinges 116 connect the brow bar 110 to the projections 118. Other suitable configurations can be used.

The bridge 114 extends in a region generally corresponding to the region between the eyes of a user. In the illustrated arrangement, the brow bar 110 actually is formed in two portions that are connected by the bridge 114. Other suitable configurations can be used including, but not limited to, a brow bar that forms at least a portion of, or, in some embodiments, the entirety of, the bridge 114. Any of the above described components of the frame assembly 102 may be omitted or integrated with other components in some embodiments. For instance, the temples 112 can be omitted where other technology or other structure is used to secure the eyewear in position in the proximity of the user's eyes. The frame assembly 102 also can comprise other structures, such as nose pads and the structures that connect the nose pads to the rest of the frame assembly 102.

With reference now to FIG. 2, the lens subframe assembly 104 in the arrangement of FIGS. 1-6 comprises a pair of lenses 120. A brow bar 122 and a bridge 124 combine in the illustrated arrangement to define a rigid frame structure of the lens subframe assembly 104. Preferably, the brow bar 122 and the bridge 124 have a smaller profile in front view such that the brow bar 122 and the bridge 124 of the subframe assembly 104 can be concealed by the brow bar 110 and the bridge 114 of the frame assembly 102, as shown by the hidden lines in FIG. 1.

The subframe assembly 104 preferably is of the rimless or semirimless variety. Such an arrangement increases the number of alternative frame constructions that can be used as the frame assembly while allowing the presence of the subframe assembly 104 to be masked. In the arrangement of FIGS. 1-6, the subframe assembly 104 comprises a lower nylon cord 126 that secures the lenses 120 to the brow bar 122. Other manners of securing the lenses 120 within or to the subframe assembly 104 can be used. For instance, in some arrangements, the lenses 120 can be secured with clamps, mechanical fasteners, threaded fasteners, encircling frames, eyewires or the like.

As described above, the subframe assembly 104 advantageously mounts to the frame assembly 102 in a manner that provides an appearance of integrated eyewear rather than removably connected lenses and frames. As such, in the illustrated arrangement, the subframe assembly 104 mounts behind the frame assembly 102 and the mounting structures are positioned behind the frame assembly 102 such that the mounting structures are generally obscured from the sight of one viewing the frame assembly 102 from the front.

With reference to FIGS. 4 and 6, the bridge 124 of the subframe assembly 104 is positioned behind the bridge 114 of the frame assembly 102. A flange 130 extends rearward from the bridge 114 of the illustrated frame assembly 102. The flange can have any suitable configuration. Desirably, the flange 130 is configured to have a vertical dimension that is the same as or less than a vertical dimension of the bridge 114 of the frame assembly 102. The flange 130 in the illustrated arrangement comprises a wire-type of member that extends rearward and curves upward to define a hook. The flange 130 has an offset that is slightly larger than the thickness of the bridge 124 of the subframe assembly 124. The bridge 124 of the subframe assembly 104 can be placed in a valley 132 defined between the flange 130 and the bridge 114 of the frame assembly 102. In a presently preferred configuration, the bridge 124 is supported by the flange 130. In other configurations, the flange 130 can be omitted or the bridge is not supported by the flange 130. Using the flange 130 to support the bridge 124 increases the structural integrity and facilitates the fitting of the subframe assembly 104 to the frame assembly 102.

With reference to FIGS. 4 and 5, an outer portion of the illustrated subframe assembly 104 comprises lugs 134 that extend laterally outward from the brow bars 122. The lugs 134 are sized and configured to abut upon bosses 136 defined on the frame assembly 102. The bosses 136 can be integrally formed with the frame assembly 102 or, as in the illustrated arrangement, can be separate components that are secured to the frame assembly. In the illustrated arrangement, the bosses 136 advantageously are positioned behind the projections 118 such that the bosses 136 are generally concealed as are the lugs 134 when the lugs 134 abut the bosses 136. Moreover, in the illustrated arrangement, the bosses 136 support the lugs 134 such that the frame assembly 102 supports the outer portions of the subframe assembly 104. In some arrangements, the bosses 136 can be positioned above or to one side of the lugs 134 and interlocking configurations can be used to connect the two components.

With continued reference to FIG. 5, the illustrated lugs 134 comprise a lower lip 140. The lower lip 140 preferably is sized and configured to abut a surface of the respective boss 136. That is, the lower lip 140 helps secure the lug 134 to the boss 136. To further secure the lug 134 and the boss 136 together, the eyewear 100 comprises interconnecting components. More particularly, in the illustrated arrangement, the eyewear 100 comprises a magnetic interlock comprising at least one magnetic member. Even more particularly, the magnetic interlock is formed by each lug and boss combination and comprises a first magnetic member 142 and a second magnetic member 144. In some configurations, one of the magnetic members 142, 144 may be slightly recessed and the other of the magnetic members 142, 144 may extend into the recess to define a mechanical interlock in addition to defining a magnetic interlock. Other suitable configurations also can be used. Also, the magnetic members 142, 144 can have any desired orientation relative to each other. In other words, while the illustrated arrangement features the first magnetic member 142 being positioned above the second magnetic member 144, other arrangements can place the first magnetic member 142 to any side of the second magnetic member 144 or can place the first magnetic member 142 below the second magnetic member 144.

In use, the illustrated frame assembly 102 generally defines the components associated with most eyewear: the brow bar 110, the bridge 114 and the temples 112. In some arrangements, such as the illustrated arrangement, the frame assembly 102 also comprises nose pads. To provide the lenses, a user slips the subframe assembly 104 behind the frame assembly 102 with the bridge 124 of the subframe assembly 104 slipping into the valley 132 while the lugs 134 are brought into abutment with the bosses 136. In such a position, the lugs 134 and the bridge 124 of the subframe assembly are generally concealed from the front of the eyewear and the lenses 120 that are positioned in the subframe assembly 104 appear to be part of the frame assembly 102. Nonetheless, when the user desires, the lenses 120 and the subframe assembly 104 can be lifted from behind the frame assembly 102 and an alternative set of lenses and subframe assembly can be placed in the frame assembly 102 or the lenses 120 and the subframe assembly 104 can be placed in an alternative frame assembly.

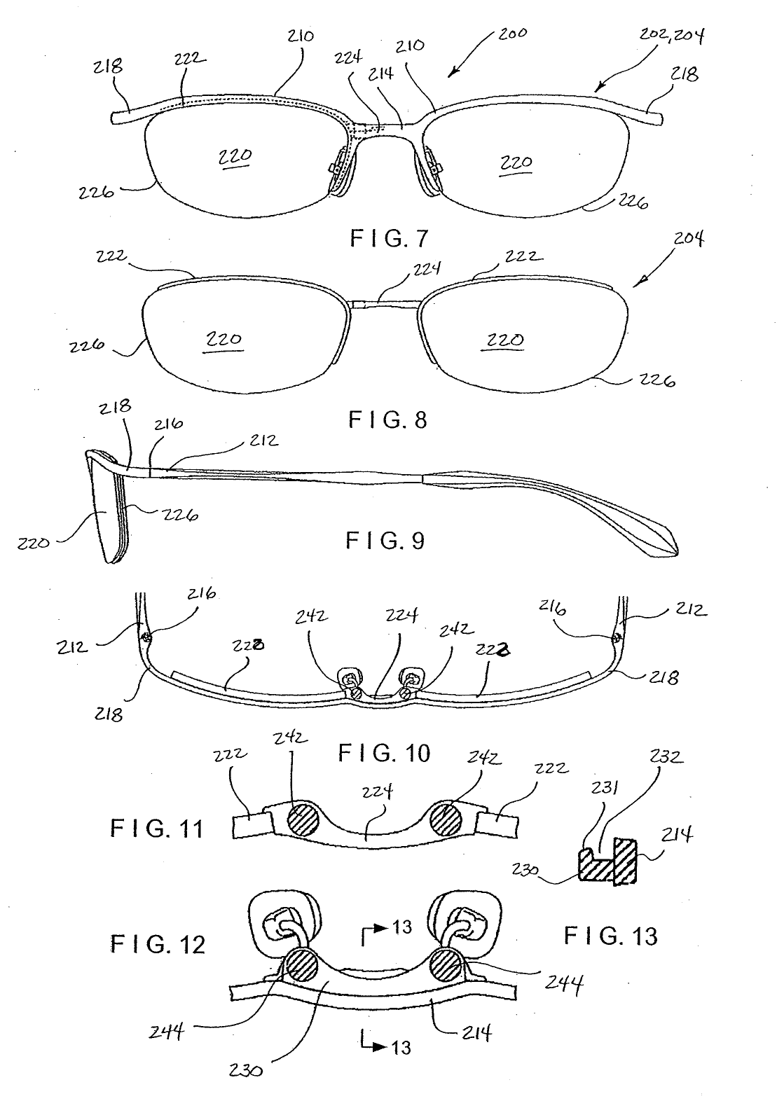

With reference now to FIGS. 7-13, another arrangement of eyewear 200 generally comprises a frame assembly 202 and a lens subframe assembly 204 (see, for example, FIG. 8). The lens subframe assembly 204 preferably is mountable to the frame assembly 202 rearward of the frame assembly 202 such that at least a portion, and preferably the majority, of the lens subframe assembly 204 will be positioned between the frame assembly 202 and the head of a wearer.

The frame assembly 202 preferably comprises a brow bar 210, a pair of temples 212 (see FIG. 9) and a bridge 214. The brow bar 210 and the temples 212 can be connected in any suitable manner. In the arrangement illustrated in FIGS. 1 and 3, corresponding hinges 216 connect the temples 212 to the brow bar 210. More particularly, projections 218 extend from the brow bar 210 and the hinges 216 connect the brow bar 210 to the projections 218. Other suitable configurations can be used.

The bridge 214 extends in a region generally corresponding to the region between the eyes of a user. In the illustrated arrangement, the brow bar 210 is formed in two portions that are connected by the bridge 214. Other suitable configurations can be used, including but not limited to, a brow bar that forms at least a portion of, or, in some embodiments, the entirety of, the bridge 214. The above described components of the frame assembly 202 may be omitted or integrated with other components in some embodiments. For instance, the temples 212 can be omitted where other technology or other structure is used to secure the eyewear in position in the proximity of the user's eyes and the hinges 216 can be omitted in some configurations.

With reference now to FIG. 8, the lens subframe assembly 204 in the arrangement of FIGS. 7-13 comprises a pair of lenses 220. A brow bar 222 and a bridge 224 combine in the illustrated arrangement to define a rigid frame structure of the lens subframe assembly 204. Preferably, the brow bar 222 and the bridge 224 have a smaller profile in front view such that the brow bar 222 and the bridge 224 of the subframe assembly 204 can be substantially concealed by the brow bar 210 and the bridge 214 of the frame assembly 202, as shown by the hidden lines in FIG. 7.

The subframe assembly 204 preferably is of the rimless or semirimless variety. Such an arrangement increases the number of alternative frame constructions that can be used as the frame assembly while allowing the presence of the subframe assembly 204 to be masked. In the arrangement of FIGS. 7-13, the subframe assembly 204 comprises a lower nylon cord 226 that secures the lenses 220 to the brow bar 222. Other manners of securing the lenses 220 within or to the subframe assembly 204 can be used. For instance, in some arrangements, the lenses 220 can be secured with clamps, mechanical fasteners, threaded fasteners, encircling frames, eyewires or the like.

As described above, the subframe assembly 204 advantageously mounts to the frame assembly 202 in a manner that provides an appearance of integrated eyewear rather than an appearance of removably connected lenses and frames. As such, in the illustrated arrangement, the subframe assembly 204 mounts behind the frame assembly 202 and the mounting structures are positioned behind the frame assembly 202 such that the mounting structures are generally obscured from the sight of one viewing the frame assembly 202 from the front.

With reference to FIG. 10, the bridge 224 of the subframe assembly 204 is positioned behind the bridge 214 of the frame assembly 202. A protrusion 230 extends rearward from the bridge 214 of the frame assembly 202. In some arrangements, more than one protrusion 230 can extend rearward from the bridge 214. The protrusion 230 can have any suitable configuration. Desirably, the protrusion 230 is configured to have a vertical dimension that is the same as or less than a vertical dimension of the bridge 214 of the frame assembly 202.

The protrusion 230 in the illustrated arrangement comprises a shelf-like structure with a lip 231 that extends slightly upward at a rear portion of the protrusion 230. Accordingly, the protrusion 230 can be said to define a hook. The lip 231 of the protrusion 230 is offset from the rear of the bridge 214 a distance that is slightly larger than the thickness of the bridge 224 of the subframe assembly 224. The bridge 224 of the subframe assembly 204 can be placed in a valley 232 defined between the lip 231 and the bridge 214 of the frame assembly 202. In a presently preferred configuration, the bridge 224 is supported by the protrusion 230.

With continued reference to FIGS. 11 and 12, the bridge 224 of the illustrated subframe assembly 204 comprises interlocking components. While the lip 231 defines one type of interlocking component, the illustrated arrangement also features a magnetic interlock comprising at least one magnetic member. Even more particularly, the magnetic interlock is formed by placing a magnetic member in at least one of the bridge 214 and the protrusion 230. In some configurations, such as the illustrated configuration, at least one first magnetic member 242 is placed in the bridge 214 and at least one second magnetic member 244 is placed in the protrusion 230. In some configurations, one of the magnetic members 242, 244 may be slightly recessed and the other of the magnetic members 242, 244 may extend into the recess to define a mechanical interlock in addition to defining a magnetic interlock. Other suitable configurations also can be used. For instance, the bridge 224 can be connected to a bottom surface or side surface of the protrusion 230 or the bridge 214 in some configurations and the magnetic interlock can be suitably disposed for such a connection.

In use, the illustrated frame assembly 202 generally defines the components associated with most eyewear: the brow bar 210, the bridge 214 and the temples 212. To provide the lenses, a user slips the subframe assembly 204 behind the frame assembly 202 with the bridge 224 of the subframe assembly 204 slipping into the valley 232. In such a position, the bridge 224 of the subframe assembly is generally concealed from the front of the eyewear and the lenses 220 that are positioned in the subframe assembly 204 appear to be part of the frame assembly 202. Nonetheless, when the user desires, the lenses 220 and the subframe assembly 204 can be lifted from behind the frame assembly 202 and an alternative set of lenses and subframe assembly can be placed in the frame assembly 202 or the lenses 220 and the subframe assembly 204 can be placed in an alternative frame assembly.

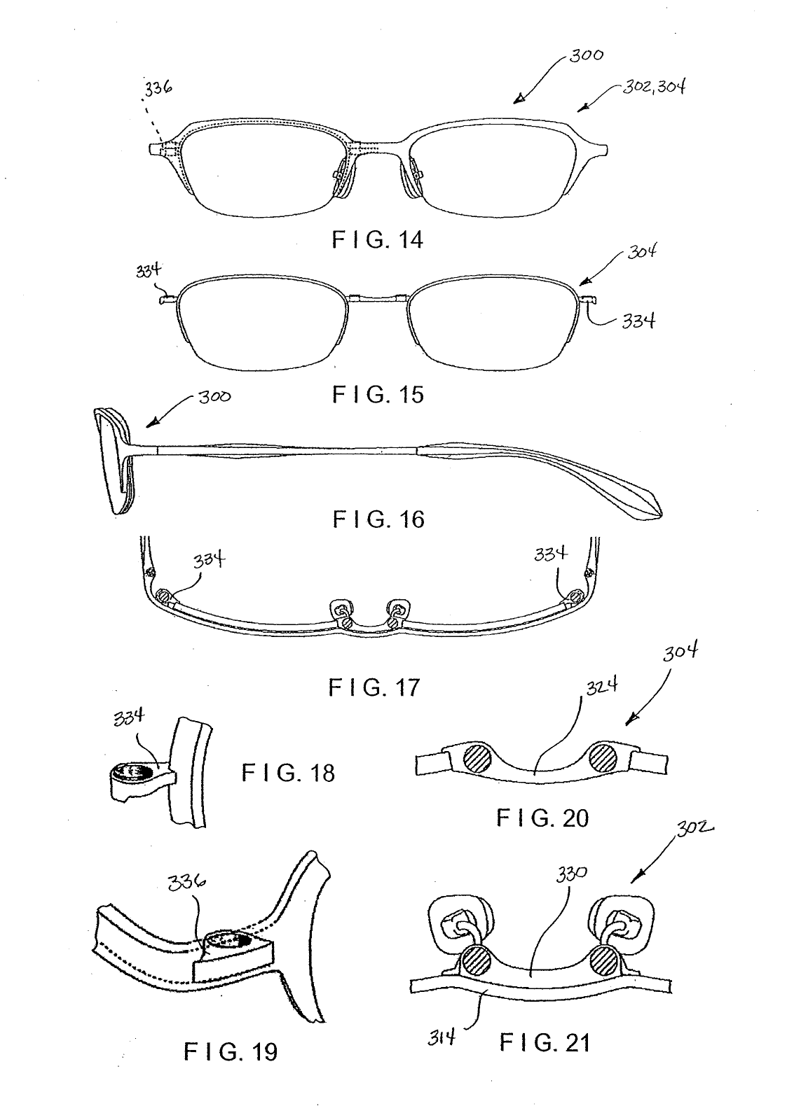

With reference now to FIGS. 14-21, another configuration of eyewear 300 arranged and configured in accordance with certain features, aspects and advantages of the present invention is illustrated. As illustrated, this arrangement comprises a frame assembly 302 and a subframe assembly 304 connectable together in a manner that combines portions of the arrangements shown in and described with reference to FIGS. 1-6 and FIGS. 7-13.

As illustrated, a bridge 324 of the subframe assembly 304 is constructed to be mounted to a protrusion 330 that extends from a bridge 314 of the frame assembly 302. Thus, this interconnection between the frame assembly 302 and the subframe assembly 304 can be substantially as that described with respect to the eyewear 200 of FIGS. 7-13.

Moreover, as illustrated, the subframe assembly comprises lugs 334 and the frame assembly comprises bosses 336. These components can be substantially as that described with respect to the eyewear 100 of FIGS. 1-6.

Because these components have been described above, further is deemed unnecessary and duplicative. Where desired or appropriate, any of the variations described above also can be used with the embodiment of FIGS. 14-21.

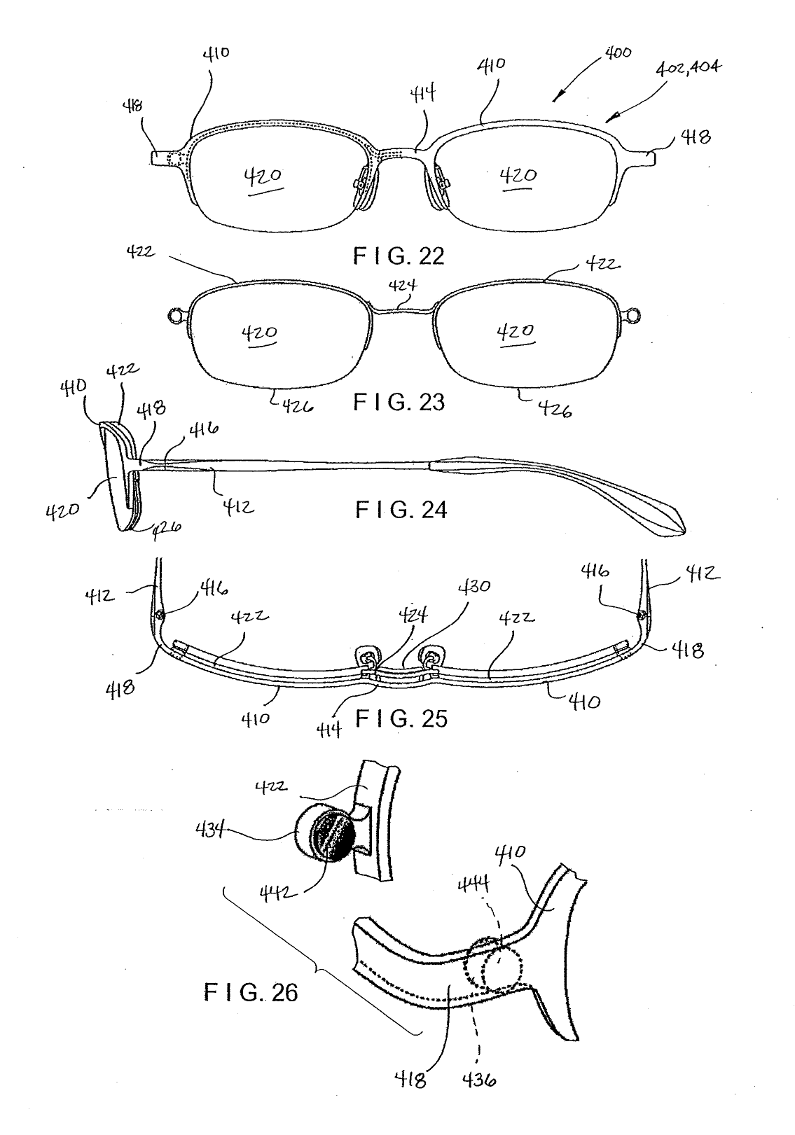

With reference now to FIGS. 22-26, another arrangement of eyewear 400 generally comprises a frame assembly 402 and a lens subframe assembly 404 (see, for example, FIG. 23). The lens subframe assembly 404 preferably is mountable to the frame assembly 402 rearward of the frame assembly 402 such that at least a portion, and preferably the majority, of the lens subframe assembly 404 will be positioned between the frame assembly 402 and the head of a wearer.

The frame assembly 402 preferably comprises a brow bar 410, a pair of temples 412 (see FIG. 24) and a bridge 414. The brow bar 410 and the temples 412 can be connected in any suitable manner. In the arrangement illustrated in FIGS. 22 and 24, corresponding hinges 416 connect the temples 412 to the brow bar 410. More particularly, projections 418 extend from the brow bar 410 and the hinges 416 connect the brow bar 410 to the projections 418. Other suitable configurations can be used.

The bridge 414 extends in a region generally corresponding to the region between the eyes of a user. In the illustrated arrangement, the brow bar 410 is formed in two portions that are connected by the bridge 414. Other suitable configurations can be used, including but not limited to, a brow bar that forms at least a portion of, or, in some embodiments, the entirety of, the bridge 414. The above described components of the frame assembly 402 may be omitted or integrated with other components in some embodiments. For instance, the temples 412 can be omitted where other technology or other structure is used to secure the eyewear in position in the proximity of the user's eyes and the hinges 416 can be omitted in some configurations.

With reference now to FIG. 2, the lens subframe assembly 404 in the arrangement of FIGS. 22-26 comprises a pair of lenses 420. A brow bar 422 and a bridge 424 combine in the illustrated arrangement to define a rigid frame structure of the lens subframe assembly 404. Preferably, the brow bar 422 and the bridge 424 have a smaller profile in front view than the brow bar 410 and bridge 414 of the frame assembly 402 such that the brow bar 422 and the bridge 424 of the subframe assembly 404 can be substantially concealed by the brow bar 410 and the bridge 414 of the frame assembly 402, as shown by the hidden lines in FIG. 22.

The subframe assembly 404 preferably is of the rimless or semirimless variety. Such an arrangement increases the number of alternative frame constructions that can be used as the frame assembly 402 while allowing the presence of the subframe assembly 404 to be masked. In the arrangement of FIGS. 22-26, the subframe assembly 404 comprises a lower nylon cord 426 that secures the lenses 420 to the brow bar 422. Other manners of securing the lenses 420 within or to the subframe assembly 404 can be used. For instance, in some arrangements, the lenses 420 can be secured with clamps, mechanical fasteners, threaded fasteners, encircling frames, eyewires or the like.

As described above, the subframe assembly 404 advantageously mounts to the frame assembly 402 in a manner that provides an appearance of integrated eyewear rather than removably connected lenses and frames. As such, in the illustrated arrangement, the subframe assembly 404 mounts behind the frame assembly 402 and the mounting structures are positioned behind the frame assembly 402 such that the mounting structures are generally obscured from the sight of one viewing the frame assembly 402 from the front.

With reference to FIG. 25, the bridge 424 of the subframe assembly 404 is positioned behind the bridge 414 of the frame assembly 402. A flange 430 extends rearward from the bridge 414 of the frame assembly 402. The flange 430 can have any suitable configuration and can be configured to cooperate with the bridge 424 as described above with respect to the eyewear 100 of FIGS. 1-6 and the eyewear 200 of FIGS. 7-13.

With reference to FIGS. 22 and 26, an outer portion of the subframe assembly 404 comprises lugs 434 that extend laterally outward from the brow bars 422. The lugs 434 are sized and configured to abut upon bosses 436 defined on the frame assembly 102. The bosses 436 can be integrally formed with the frame assembly 402 or, as in the illustrated arrangement, can be separate components that are secured to the frame assembly and project rearwardly therefrom. In the illustrated arrangement, the bosses 436 advantageously are positioned behind the projections 418 such that the bosses 436 are generally concealed as are the lugs 434 when the lugs 434 abut the bosses 436. The lugs 434 can be positioned in any desired orientation relative to the bosses 436 and interlocking configurations can be used to connect the two components.

In the illustrated arrangement, the bosses 436 generally comprise magnetic members that are positioned in the projections 418 and the bosses comprise interconnecting components together with the lugs 434. More particularly, in the illustrated arrangement, the eyewear 100 comprises a magnetic interlock comprising at least one magnetic member. Even more particularly, the magnetic interlock is formed at each lug and boss combination and comprises a first magnetic member 442 and a second magnetic member 444. In some configurations, one of the magnetic members 442, 444 may be slightly recessed and the other of the magnetic members 442, 444 may extend into the recess to define a mechanical interlock in addition to defining a magnetic interlock. Other suitable configurations also can be used.

In use, the illustrated frame assembly 402 generally defines the components associated with most eyewear: the brow bar 410, the bridge 414 and the temples 412. To provide the lenses 420, a user slips the subframe assembly 404 behind the frame assembly 402 with the bridge 424 of the subframe assembly 404 slipping into the valley defined by the flange 430 while the lugs 434 are brought into abutment with the bosses 436. In such a position, the lugs 434 and the bridge 424 of the subframe assembly 404 are generally concealed from the front of the eyewear and the lenses 420 that are positioned in the subframe assembly 404 appear to be part of the frame assembly 402. Nonetheless, when the user desires, the lenses 420 and the subframe assembly 404 can be lifted from behind the frame assembly 402 and an alternative set of lenses and subframe assembly can be placed in the frame assembly 402 or the lenses 420 and the subframe assembly 404 can be placed in an alternative frame assembly.

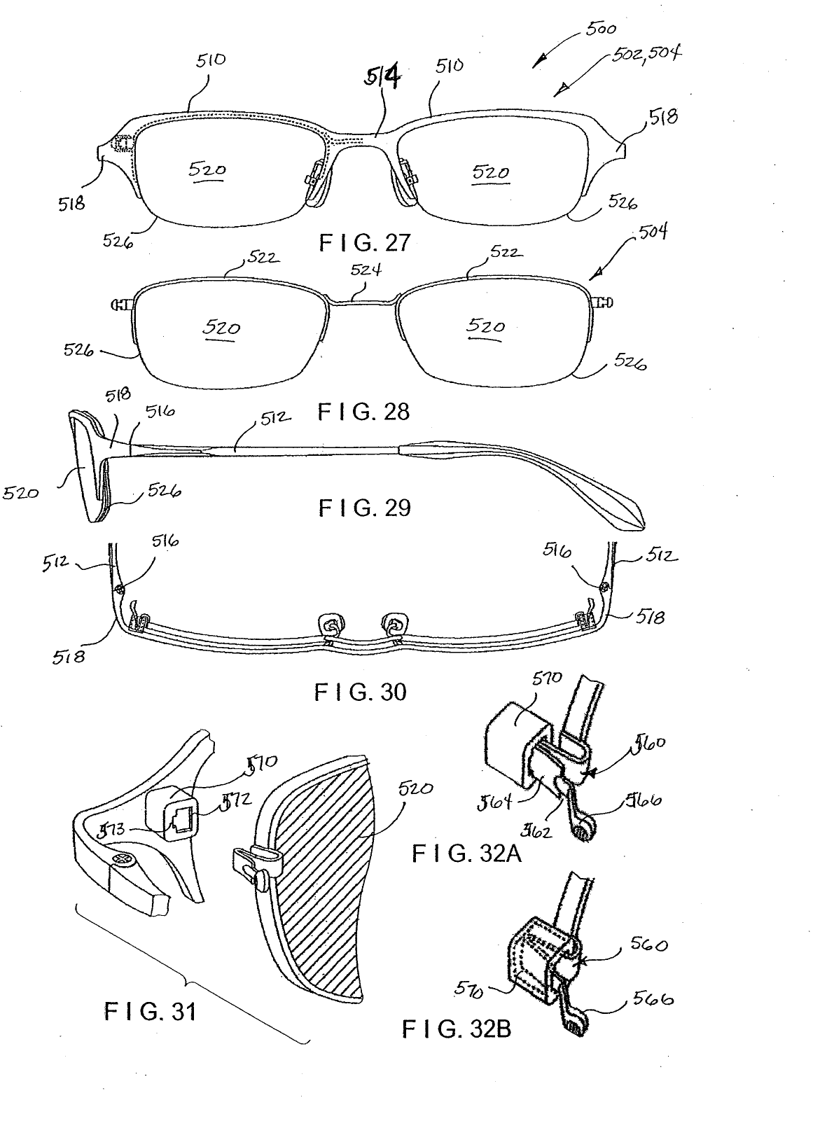

With reference now to FIGS. 27-32B, another arrangement of eyewear 500 generally comprises a frame assembly 502 and a lens subframe assembly 504 (see, for example, FIG. 28). The lens subframe assembly 504 preferably is mountable to the frame assembly 502 rearward of the frame assembly 502 such that at least a portion, and preferably the majority, of the lens subframe assembly 504 will be positioned between the frame assembly 502 and the face of a wearer.

The frame assembly 502 preferably comprises a brow bar 510, a pair of temples 512 (see FIG. 29) and a bridge 514. The brow bar 510 and the temples 512 can be connected in any suitable manner. In the arrangement illustrated in FIGS. 29 and 30, corresponding hinges 516 connect the temples 512 to the brow bar 510. More particularly, projections 518 extend from the brow bar 510 and the hinges 516 connect the brow bar 510 to the projections 518. Other suitable configurations can be used.

The bridge 514 extends in a region generally corresponding to the region between the eyes of a user. In the illustrated arrangement, the brow bar 510 is formed in two portions that are connected by the bridge 514. Other suitable configurations can be used, including but not limited to, a brow bar that forms at least a portion of, or, in some embodiments, the entirety of, the bridge 514. The above described components of the frame assembly 502 may be omitted or integrated with other components in some embodiments. For instance, the temples 512 can be omitted where other technology or other structure is used to secure the eyewear in position in the proximity of the user's eyes and the hinges 516 can be omitted in some configurations.

With reference now to FIG. 28, the lens subframe assembly 504 in the arrangement of FIGS. 27-32B comprises a pair of lenses 520. A brow bar 522 and a bridge 524 combine in the illustrated arrangement to define a rigid frame structure of the lens subframe assembly 504. Preferably, the brow bar 522 and the bridge 524 have a smaller profile in front view than the brow bar 510 and the bridge 514 of the frame assembly 502 such that the brow bar 522 and the bridge 524 of the subframe assembly 504 can be substantially concealed by the brow bar 510 and the bridge 514 of the frame assembly 502, as shown by the hidden lines in FIG. 27.

The subframe assembly 504 preferably is of the rimless or semirimless variety. Such an arrangement increases the number of alternative frame constructions that can be used as the frame assembly while allowing the presence of the subframe assembly 504 to be masked. In the arrangement of FIGS. 27-32B, the subframe assembly 504 comprises a lower nylon cord 526 that secures the lenses 520 to the brow bar 522. Other manners of securing the lenses 520 within or to the subframe assembly 504 can be used. For instance, in some arrangements, the lenses 520 can be secured with clamps, mechanical fasteners, threaded fasteners, encircling frames, eyewires or the like.

As described above, the subframe assembly 504 advantageously mounts to the frame assembly 502 in a manner that provides an appearance of integrated eyewear rather than an appearance of removably connected lenses and frames. As such, in the illustrated arrangement, the subframe assembly 504 mounts behind the frame assembly 502 and the mounting structures are positioned behind the frame assembly 502 such that the mounting structures are generally obscured from the sight of one viewing the frame assembly 502 from the front.

With reference to FIG. 10, the bridge 524 of the subframe assembly 504 is positioned behind the bridge 514 of the frame assembly 502. In the illustrated arrangement, the bridge 524 of the subframe assembly 504 is not directly supported by any structure associated with the frame assembly 502. In other arrangements, the bridge 524 may be supported.

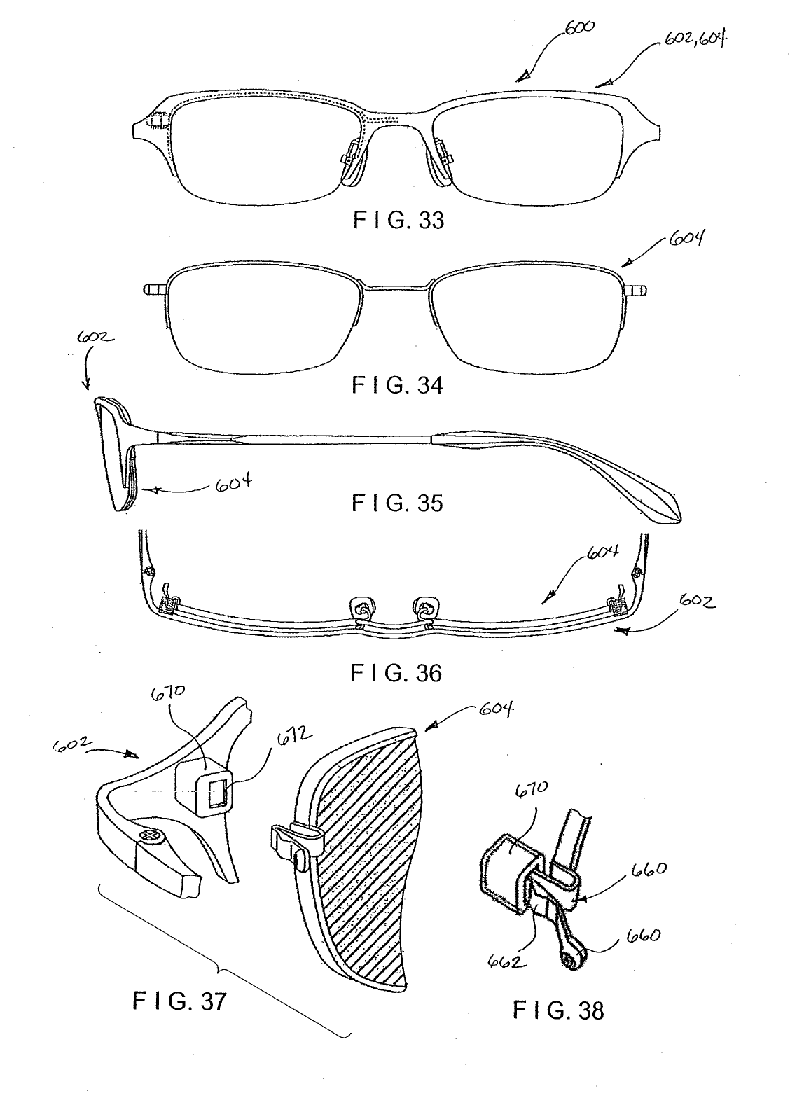

With reference to FIGS. 31, 32A and 32B, the subframe assembly 504 generally comprises a locking tab 560 that extends forward from the subframe assembly 504. The illustrated tab 560 comprises an N-shaped configuration but can comprise any suitable configuration in other arrangements, including a V-shape or a W-shape configuration. The tab 560 also comprises a clip portion 562 that is defined between a main body 564 and a finger hold 566 of the tab.

The frame assembly 502 preferably comprises a receptacle 570. The receptacle 570 defines an aperture 572 sized and configured to accept at least a portion of the tab 560. The illustrated aperture 572 is generally square or rectangular with a slot 573 defined along one side. As illustrated in FIG. 32B, the slot 573 receives the clip portion 562 of the tab 560 when the tab 560 is fully positioned within the receptacle 570. In other words, a shoulder that is defined at approximately the clip portion 562 is captured within the receptacle while the clip portion 562 is positioned in the slot 573 of the aperture 572 with the finger hold 566 protruding from the receptacle 570.

Thus, in the illustrated arrangement, the tab 560 and the receptacle 570 define a mechanical interlock. The tab 560 can be positioned on either one of the frame assembly 502 and the subframe assembly 504 while the receptacle 570 is positioned on the other. Positioning the tab 560 on the subframe assembly 504, however, allows easier removal of the subframe assembly 504 from the frame assembly 502.

In use, the illustrated frame assembly 502 generally defines the components associated with most eyewear: the brow bar 510, the bridge 514 and the temples 512. To provide the lenses, a user slips the subframe assembly 504 behind the frame assembly 502 with the tab 560 being inserted into the receptacle 570 of the frame assembly 502. In such a position, the bridge 524 of the subframe assembly 504 is generally concealed from the front of the eyewear and the lenses 520 that are positioned in the subframe assembly 504 appear to be part of the frame assembly 502. Nonetheless, when the user desires, the lenses 520 and the subframe assembly 504 can be removed from behind the frame assembly 502 and an alternative set of lenses and subframe assembly can be placed in the frame assembly 502 or the lenses 520 and the subframe assembly 504 can be placed in an alternative frame assembly.

With reference now to FIGS. 33-38, another configuration of eyewear 600 arranged and configured in accordance with certain features, aspects and advantages of the present invention is illustrated. As illustrated, this arrangement comprises a frame assembly 602 and a subframe assembly 604 connectable together in a manner similar to that shown in FIGS. 27-32B. The portions that are the same as the arrangements described above will not be described in this embodiment.

As illustrated, a tab 660 and a receptacle 670 provide a mechanical interlock. The tab 660 differs from the tab 560 described above in that the tab 660 comprises a bulge 662 that is received within the receptacle 670 to lock the tab 660 into the receptacle. As such, the receptacle can have a generally square or rectangular aperture 672 without the need for a slot such as that shown in FIG. 31. The bulge 662 can be pushed into the receptacle 670 through the aperture 672. To remove the tab 660 from the receptacle, a finger hold 666 can be depressed which results in movement of the bulge into a position that allows the tab 660 to be withdrawn from the receptacle 670.

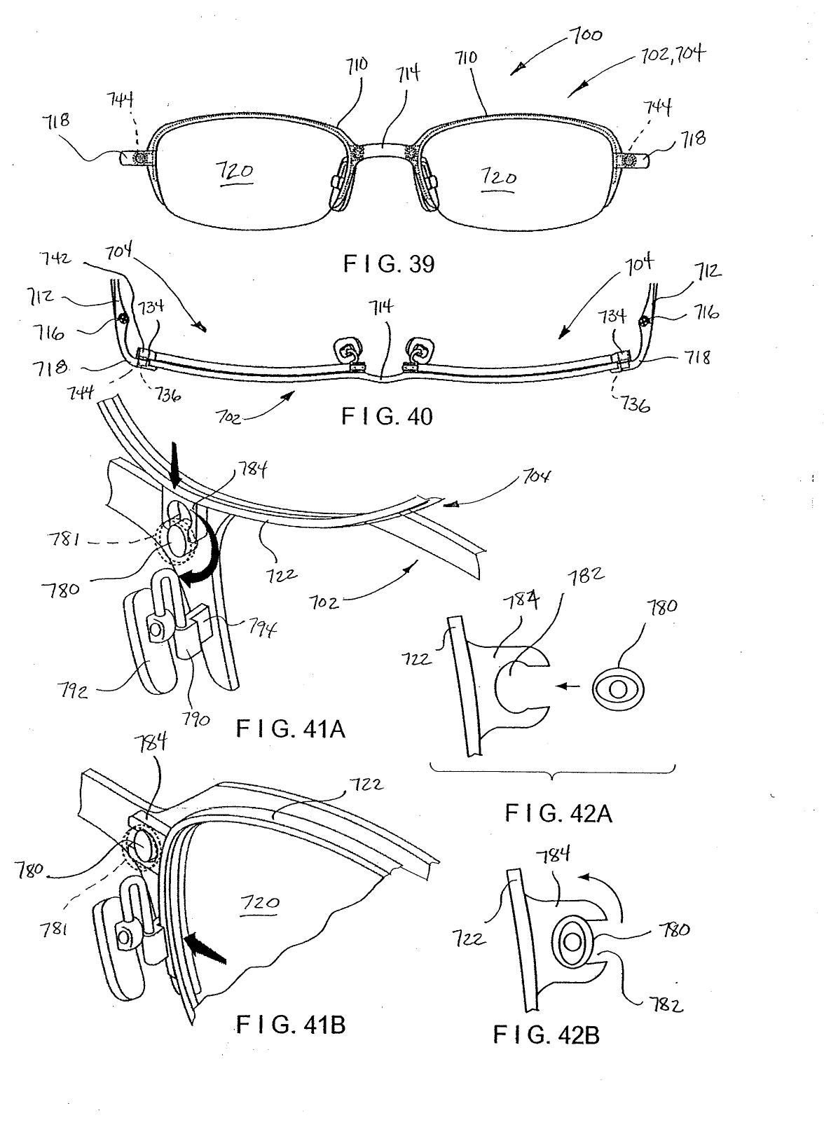

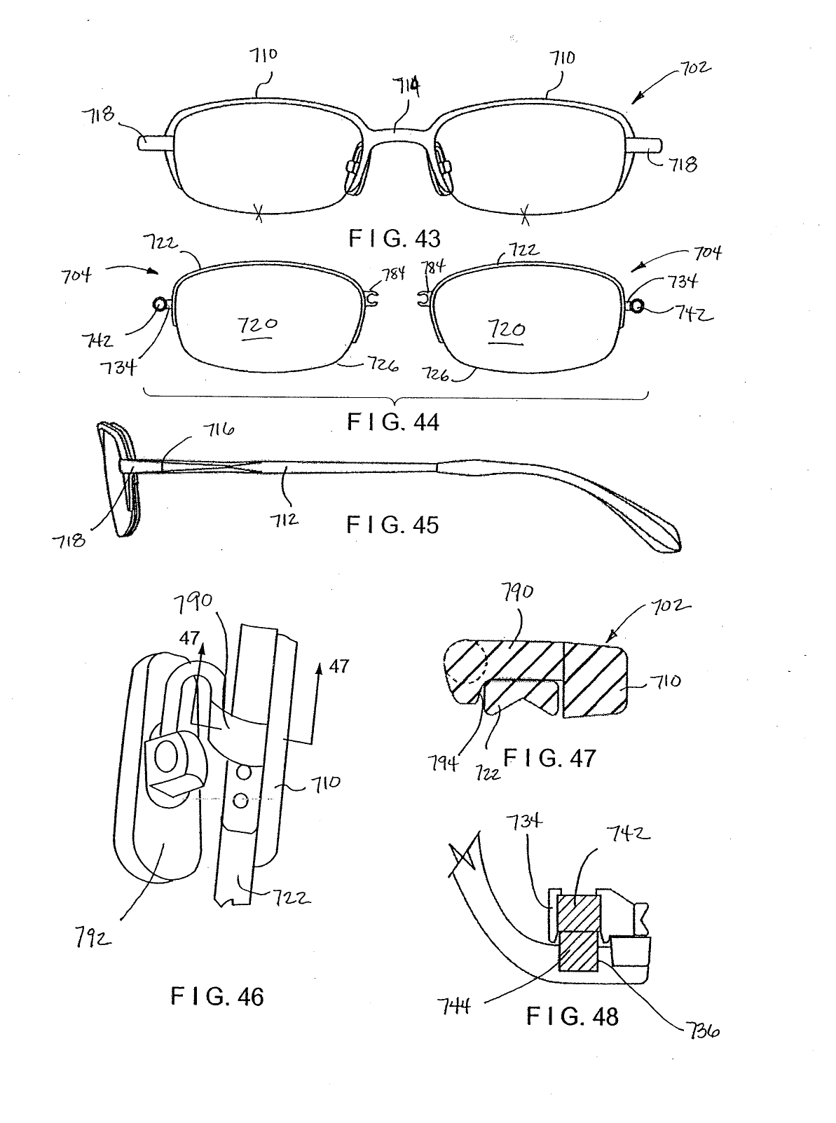

With reference now to FIGS. 39-48, another arrangement of eyewear 700 generally comprises a frame assembly 702 and a pair of lens subframe assemblies 704 (see FIG. 44). Each of the lens subframe assemblies 704 preferably is mountable to the frame assembly 702 rearward of the frame assembly 702 such that at least a portion, and preferably the majority, of the lens subframe assembly 704 will be positioned between the frame assembly 702 and the eye of a wearer.

The frame assembly 702 preferably comprises a brow bar 710, a pair of temples 712 (see FIG. 40) and a bridge 714. The brow bar 710 and the temples 712 can be connected in any suitable manner. In the arrangement illustrated in FIG. 40, corresponding hinges 716 connect the temples 712 to the brow bar 710. More particularly, projections 718 extend from the brow bar 710 and the hinges 716 connect the brow bar 710 to the projections 718. Other suitable configurations can be used.

The bridge 714 extends in a region generally corresponding to the region between the eyes of a user. In the illustrated arrangement, the brow bar 710 is formed in two portions that are connected by the bridge 714. Other suitable configurations can be used including but not limited to a brow bar that forms at least a portion, or, in some embodiments, the entirety of, the bridge 714. The above described components of the frame assembly 702 may be omitted or integrated with other components in some embodiments. For instance, the temples 712 can be omitted where other technology or other structure is used to secure the eyewear in position in the proximity of the user's eyes and the hinges 716 can be omitted in some configurations.

With reference now to FIGS. 41A-42B, each of the lenses 720 is secured to the frame assembly 702 with a separate lens subframe assembly 704. Thus, the lens subframes do not comprise a bridge in this arrangement. The lens subframe assembly 704 comprises a version of a brow bar 722 to which the lens 720 is secured. The brow bar 722 desirably has a smaller profile in front view than the brow bar 710 of the frame assembly 702 such that the brow bar 722 of the subframe assembly 704 can be substantially concealed by the brow bar 710 of the frame assembly 702, as shown by the hidden lines in FIG. 39.

The subframe assemblies 704 preferably are of the rimless or semirimless variety. Such an arrangement increases the number of alternative frame constructions that can be used as the frame assembly while allowing the presence of the subframe assemblies 704 to be masked. In the one configuration, the subframe assembly 704 comprises a lower nylon cord 726 that secures the lenses 720 to the brow bar 722 of the subframe assembly 704. Other manners of securing the lenses 720 within or to the subframe assembly 704 can be used. For instance, in some arrangements, the lenses 720 can be secured with clamps, mechanical fasteners, threaded fasteners, encircling frames, eyewires or the like.

As described above, the subframe assembly 704 advantageously mounts to the frame assembly 702 in a manner that provides an appearance of integrated eyewear rather than an appearance of removably connected lenses and frames. As such, in the illustrated arrangement, the subframe assembly 704 mounts behind the frame assembly 702 and the mounting structures are positioned behind the frame assembly 702 such that the mounting structures are generally obscured from the sight of one viewing the frame assembly 702 from the front.

With reference to FIG. 39, the illustrated subframe assemblies 704 are secured to the frame assembly 702 at in two locations. In one arrangement, such as the illustrated arrangement, the subframe assemblies 704 are secured at both lateral ends of the subframe assemblies 704. In a presently preferred configuration, one end of the subframe assembly 704 is secured by a mechanical interlock while the other end is secured by a magnetic interlock.

With reference now to FIGS. 41A-42B, one form of the mechanical interlock between the subframe assembly 704 and the frame assembly 702 will be described. As illustrated, the frame assembly comprises an oblong post 780. The oblong post 780 extends rearward from the frame assembly 702 and preferably has a major diameter that extends generally vertically and a minor diameter that extends generally laterally. Other shapes and configurations of the post can be used and the post can be placed on the subframe assembly 704 in some configurations. Moreover, in one preferred arrangement, an enlarged head 781 (shown in dashed lines in FIGS. 41A and 41B) is provided on the post 780 such that a major portion of the post 780 has a smaller cross-section than the head. In some particularly advantageous embodiments, the post comprises a magnetic member.

The subframe assembly 704 preferably comprises a slot 782 that is defined within an ear 784. In some particularly advantageous embodiments, the ear 784 comprises a magnetic member that can be magnetically secure to the post 780. A portion of the slot 782 preferably is oblong such that the post 780 can be inserted and the lens rotated into a locked position. As with the post, other configurations can be used and the slot can be disposed on the frame assembly 702 in some configurations. As shown in FIG. 41A, the slot 782 can slid onto the post 780 and the subframe assembly 704 can be rotated to lock the subframe assembly 704 to the frame assembly 702, as shown in FIG. 41B.

With reference to FIGS. 39, 40 and 48, lugs 734 can be an outer portion of the illustrated subframe assembly 704 comprises lugs 734 that extend laterally outward from the brow bars 722. The lugs 734 are sized and configured to abut upon bosses 736 defined on the frame assembly 702. The bosses 736 can be integrally formed with the frame assembly 702 or can be separate components that are secured to the frame assembly 702. In the illustrated arrangement, the bosses 736 advantageously are positioned behind the projections 718 such that the bosses 736 are generally concealed as are the lugs 734 when the lugs 734 abut the bosses 736.

In the illustrated arrangement, the bosses 736 generally comprise magnetic members that are positioned in the projections 718 and the bosses 736 comprise interconnecting components together with the lugs 734. More particularly, in the illustrated arrangement, the eyewear 700 comprises a magnetic interlock comprising at least one magnetic member. Even more particularly, the magnetic interlock is formed at each lug and boss combination and comprises a first magnetic member 742 and a second magnetic member 744. In some configurations, one of the magnetic members 742, 744 may be slightly recessed and the other of the magnetic members 742, 744 may extend into the recess to define a mechanical interlock in addition to defining a magnetic interlock. Other suitable configurations also can be used. Moreover, the post 780 and the ear 784 can be interchanged in location with the boss 736 and the lug 734 in some applications.

With reference to FIG. 41A and 47, a post 790 of the nose piece 792 can comprise a reduced portion 794. The reduced portion 794 can accommodate a portion of either the lens 720 or the subframe assembly 704 such that the reduced portion 794 can serve to locate the lens 720 relative to the frame assembly 702 and provide another member that helps lock the subframe assembly 704 in position.

In use, the illustrated frame assembly 702 generally defines the components associated with most eyewear: the brow bar 710, the bridge 714 and the temples 712. To provide the lenses, a user slips the subframe assembly 704 behind the frame assembly 702 and slips the post 780 into the slot 782 of the ear 784. The subframe assembly 704 is then rotated about 90 degrees and the lug 734 is brought into engagement with the boss 736 such that the subframe assembly 704 is supported in a generally locked position relative to the frame assembly 702. The other lens 720 can be installed to the frame assembly 702 in the same manner. In such a position, the subframe assembly 704 is generally concealed from the front of the eyewear and the lenses 720 that are positioned in the subframe assembly 704 appear to be part of the frame assembly 702. Nonetheless, when the user desires, the lenses 720 and the subframe assemblies 704 can be removed from behind the frame assembly 702 and an alternative set of lenses and subframe assemblies can be placed in the frame assembly 702 or the lenses 720 and the subframe assemblies 704 can be placed in an alternative frame assembly.

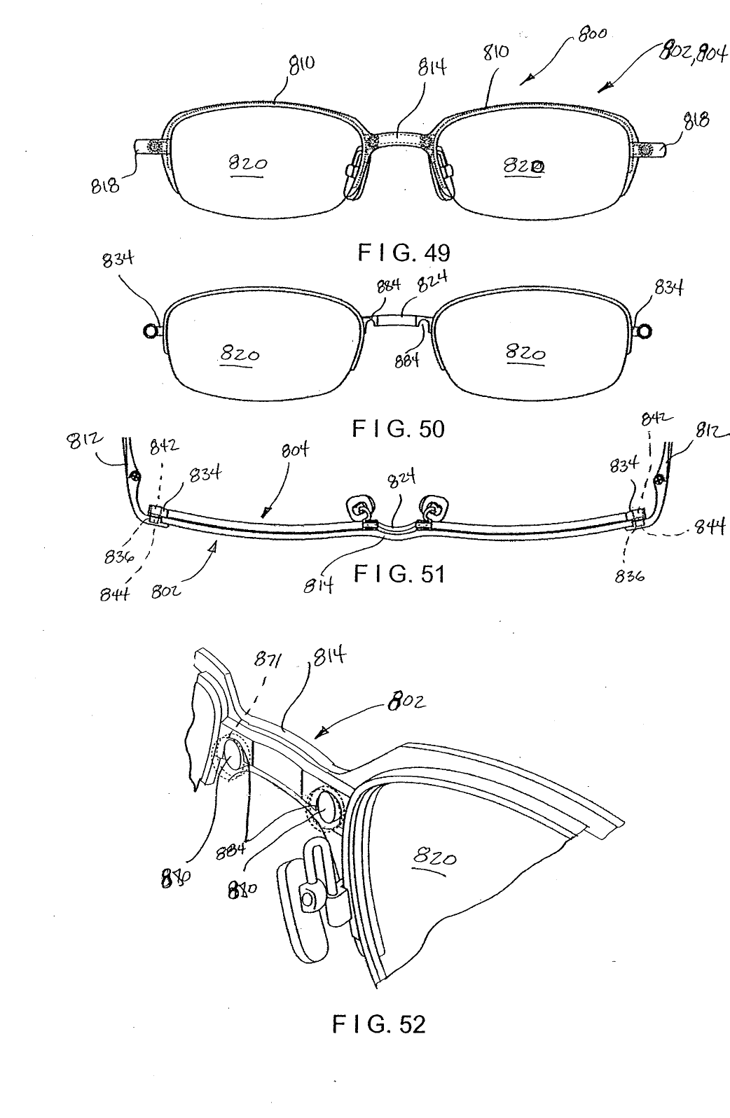

With reference now to FIGS. 49-52, an eyewear assembly 800 is shown. The eyewear assembly 800 features a frame assembly 802 to which a subframe assembly 804 can be mounted. Because of the similarity to the arrangements described above, many of the base components of the frame assembly 802 and the subframe assembly 804 will not be described in further detail. Rather, reference may be had to the descriptions set forth above for such components. For instance, the frame assembly 802 is very similar to the frame assembly 702 described with reference to FIGS. 39-48.

A primary difference between the prior embodiment and the embodiment of FIGS. 49-50 is the use of a single subframe assembly 804. The subframe assembly 804 comprises a bridge 824 that connects a pair of brow bars 822. The bridge 824 in the illustrated arrangement comprises a pair of slots 882 that can receive a corresponding pair of posts 870. The posts can be configured in any suitable manner, including the manners set forth in the embodiment above. The slots 882 and the posts 870 define a mechanical interlock between the frame assembly 802 and the subframe assembly 804.

As with the arrangement described directly above, a magnetic interlock also is provided. Any suitable construction can be used and, in the illustrated arrangement, the magnetic interlock is the same as the arrangement in the embodiment described directly above. Accordingly, a pair of lugs 834 is positioned on an outer portion of the illustrated subframe assembly 804. The lugs 834 are sized and configured to abut upon bosses 836 defined on the frame assembly 802. The bosses 836 can be integrally formed with the frame assembly 802 or can be separate components that are secured to the frame assembly 802. In the illustrated arrangement, the bosses 836 advantageously are positioned behind projections 818 such that the bosses 836 are generally concealed as are the lugs 834 when the lugs 834 abut the bosses 836.

In the illustrated arrangement, the bosses 836 generally comprise magnetic members that are positioned in the projections 818 and the bosses 836 comprise interconnecting components together with the lugs 834. More particularly, in the illustrated arrangement, the eyewear 800 comprises a magnetic interlock comprising at least one magnetic member. Even more particularly, the magnetic interlock is formed at each lug and boss combination and comprises a first magnetic member 842 and a second magnetic member 844. In some configurations, one of the magnetic members 842, 844 may be slightly recessed and the other of the magnetic members 842, 844 may extend into the recess to define a mechanical interlock in addition to defining a magnetic interlock. Other suitable configurations also can be used. Moreover, the posts 880 and slots 884 can be interchanged in location with the boss 836 and the lug 834 in some applications.

In use, the illustrated frame assembly 802 generally defines the components associated with most eyewear: the brow bar 810, the bridge 814 and the temples 812. To provide the lenses 820, a user slips the subframe assembly 804 behind the frame assembly 802 with the slots 884 being slid onto the posts 880 of the frame assembly 502. In such a position, the bridge 824 of the subframe assembly 804 is generally concealed from the front of the eyewear and the lenses 820 that are positioned in the subframe assembly 804 appear to be part of the frame assembly 802. Nonetheless, when the user desires, the lenses 820 and the subframe assembly 804 can be removed from behind the frame assembly 802 and an alternative set of lenses and subframe assembly can be placed in the frame assembly 802 or the lenses 820 and the subframe assembly 804 can be placed in an alternative frame assembly.

Although the present invention has been disclosed in the context of certain preferred embodiments, examples and variations, it will be understood by those skilled in the art that the present invention extends beyond the specifically disclosed embodiments to other alternative embodiments and/or uses of the invention and obvious modifications and equivalents thereof. In addition, while a number of variations of the invention have been shown and described in detail, other modifications, which are within the scope of this invention, will be readily apparent to those of skill in the art based upon this disclosure. For instance, the exterior shape and dimensions of the frame assemblies, subframe assemblies, mechanical interlocks and magnetic interlocks can be any suitable shape or configuration, including the use of curved or straight surfaces in the place of straight or curved surfaces. In addition, the connections preferably are made with the lens assembly resting on a surface of the frame assembly. In some embodiments, however, the lens assembly can be positioned such that the frame assembly rests on a portion of the lens assembly. It is also contemplated that various combinations or subcombinations of the specific features and aspects of any of the many embodiments may be made and still fall within the scope of the invention. It should be understood that various features and aspects of the disclosed embodiments can be combined with or substituted for one another in order to form varying modes of the disclosed invention. Moreover, some variations that have been described with respect to one embodiment and not another embodiment can be used with such other embodiments. For instance, the subframe assembly can be supported in one, two or more locations on the frame assembly. Many variations have been described herein and cross-application is intended where physically possible. Thus, it is intended that the scope of the present invention herein disclosed should not be limited by the particular disclosed embodiments described above, but should be determined only by a fair reading of the claims that follow.

What is claimed is:

1. An eyeglass assembly comprising a frame assembly and a subframe assembly, said frame assembly comprising a pair of temples, said frame assembly also comprising a front side and a back side, said back side of said frame assembly being closer to a wearer's face than said front side, said subframe assembly comprising at least one lens, said at least one subframe assembly comprising a front side and a back side, said back side of said subframe assembly being closer to said wearer's face than said front side of said subframe assembly, said subframe assembly being secured to said frame assembly at least in part by at least one pair of magnetic members such that said front side of said subframe assembly faces said back side of said frame assembly and said subframe assembly is at least partially positioned between said frame assembly and said wear's face, a first magnetic member of said at least one pair of magnetic members being a magnet that is secured to one of said frame assembly and said subframe assembly and a second magnetic member of said at least one pair of magnetic members being a magnet or a material that is attracted to a magnet and said second magnetic member being secured to said other of said frame assembly and said subframe assembly such that said first magnetic member and said second magnetic member are generally aligned when said subframe assembly is secured to said frame assembly.

2. The eyewear of claim 1, wherein said subframe assembly comprises said first magnetic member.

3. The eyewear of claim 2, wherein said first magnetic member is positioned generally towards said front side of said subframe assembly.

4. The eyewear of claim 3, wherein said frame assembly comprises said second magnetic member.

5. The eyewear of claim 4, wherein said second magnetic member is positioned generally toward said back side of said frame assembly.

6. An eyeglass assembly comprising a frame assembly and a subframe assembly;
said frame assembly comprising a front side and a back side, said back side being closer to a face of a wearer than said front side, said frame assembly further comprising a first brow bar, a second brow bar and a bridge connecting said first brow bar to said second brow bar, said bridge having a first vertical dimension, a first projection extending from said first brow bar and a second projection extending from said second brow bar, a first temple connected to said first projection and a second temple connected to said second projection;
said subframe assembly comprising a front side and a back side, said back side being closer to said face of a wearer than said front side, said subframe assembly further comprising a brow bar, a lens being secured to said brow bar;
said subframe assembly being secured to said frame assembly such that said front side of said subframe assembly faces said back side of said frame assembly and such that said front side of said subframe assembly generally is positioned rearward of said front side of said frame assembly.

7. The eyewear of claim 6, wherein said front side of said subframe assembly generally is positioned rearward of said rear side of said frame assembly.

8. The eyewear of claim 6, wherein said subframe assembly other than said lens, when secured to said frame assembly, is sized and positioned to be obscured from view when said eyewear is viewed from said front.

9. The eyewear of claim 6, wherein said frame assembly does not comprise any lenses.

10. The eyewear of claim 6 further comprising a second subframe assembly, said second subframe assembly comprising a front side and a back side, said back side being closer to the face of the wearer than said front side, said second subframe assembly further comprising a brow bar, a lens being secured to said brow bar, said second subframe assembly also being secured to said frame assembly such that said front side of said second subframe assembly faces said back side of said frame assembly and such that said front side of said second subframe assembly generally is positioned rearward of said front side of said frame assembly, said first and second subframe assemblies being positioned side-by-side when secured to said frame assembly.

11. The eyewear of claim 6, wherein said subframe assembly does not comprise any temples.

12. The eyewear of claim 6, wherein said subframe assembly does not comprise any nose pads.

13. The eyewear of claim 6, wherein said frame assembly comprises a boss that extends rearward and said subframe assembly comprises a lug that is connected to said brow bar, said lug being positioned on said boss when said subframe assembly is secured to said frame assembly.

14. The eyewear of claim 13, wherein said lug comprises a first magnetic member and said boss comprises a second magnetic member, said first and second magnetic members being magnetically secured when said subframe assembly is secured to said frame assembly.

15. The eyewear of claim 14, wherein said first magnetic member is slightly recessed within said lug and said second magnetic member extends into said lug when said subframe assembly is secured to said frame assembly such that said first and second magnetic members also define a mechanical interlock.

16. The eyewear of claim 6 further comprising a second brow bar, a second lens being secured to said second brow bar and said second brow bar being connected to said first brow bar by a bridge, said bridge being generally obscured from frontal view by said bridge of said frame assembly when said subframe assembly is secured to said frame assembly.

17. The eyewear of claim 16 further comprising a member being connected to said bridge of said frame assembly, said member defining a valley together with said bridge and said bridge of said subframe assembly being received within said valley.

18. A method of exchanging lenses in an eyewear system, the eyewear system comprising a first subframe assembly that comprises a first lens, a second subframe assembly that comprises a second lens, the second lens not being matched to the first lens, and a frame assembly that will accommodate individually both the first subframe assembly and the second subframe assembly, the method comprising releasing and removing the first subframe assembly from behind the frame assembly, placing the second subframe assembly behind the frame assembly and securing the second subframe assembly to the frame assembly.

19. A method of exchanging lenses in an eyewear system, the eyewear system comprising a first subframe assembly that comprises a first lens and a second lens, a second subframe assembly that comprises a different first lens and a different second lens, and a frame assembly that will accommodate individually both the first subframe assembly and the second subframe assembly, the method comprising releasing and removing the first subframe assembly from behind the frame assembly, placing the second subframe assembly behind the frame assembly and securing the second subframe assembly to the frame assembly.

20. A method of exchanging frames in an eyewear system, the eyewear system comprising a first frame assembly that does not comprise a lens, a second frame assembly that does not comprise a lens, and a subframe assembly that comprises a lens, the subframe assembly sized and configured to be accommodated within the first frame assembly and the second frame assembly, the method comprising releasing and removing the subframe assembly from behind the first frame assembly, placing the subframe assembly behind the second frame assembly and securing the subframe assembly to the second frame assembly.

21. The method of claim 18, wherein releasing and removing the first subframe assembly from behind the frame assembly does not require the use of mechanical tools.

22. The method of claim 18, wherein, once placed and secured behind the frame assembly, at least a portion of the second subframe assembly is obscured by the frame assembly.

23. The method of claim 18, wherein the second subframe assembly is secured to the frame assembly by a mechanical interconnection.

24. The method of claim 23, wherein the mechanical interconnection comprises a snap-fit member.

25. The method of claim 18, wherein the second subframe assembly is secured to the frame assembly by a magnetic interconnection.

26. The method of claim 18, wherein the second subframe assembly is secured to the frame assembly by a combination of a mechanical interconnection and a magnetic interconnection.

27. The method of claim 18, wherein removing the first subframe assembly from the frame assembly does not remove a nose piece from the frame assembly.

28. The method of claim 18, wherein removing the first subframe assembly from the frame assembly does not remove a temple from the frame assembly.

29. The method of claim 18, wherein the first subframe assembly comprises a semi-rimless construction.

30. The method of claim 18, wherein the frame assembly is separated from an eye of a wearer by at least a portion of the second subframe assembly after the second subframe assembly is secured to the frame assembly.

31. The method of claim 18, wherein the frame assembly comprises a brow bar and the second subframe assembly comprises a brow bar and the frame assembly brow bar conceals the second subframe brow bar after the second subframe assembly is secured to the frame assembly.

32. The method of claim 18, wherein the frame assembly comprises a bridge and the second subframe assembly comprises a bridge and the frame assembly bridge conceals the second subframe bridge after the second subframe assembly is secured to the frame assembly.
